(19) United States
(12) Patent Application Publication
(10) Pub. No.: US 2013/0194711 A1
(43) Pub. Date: Aug. 1, 2013

(54) SURGE ABSORBER AND METHOD FOR PRODUCING THE SAME

(71) Applicants: Yoshiyuki Tanaka, Chichibu-gun (JP); Shinji Sakai, Chichibu-gun (JP)

(72) Inventors: Yoshiyuki Tanaka, Chichibu-gun (JP); Shinji Sakai, Chichibu-gun (JP)

(21) Appl. No.: 13/816,148

(22) PCT Filed: Aug. 10, 2010
(86) PCT No.: PCT/JP2010/005018

§ 371 Date: Mar. 28, 2013

(51) Int. Cl. H01T 4/02; H01T 21/00

(52) U.S. Cl. CPC H01T 4/02; H01T 21/00
USPC 361/120; 29/825

(57) ABSTRACT

A surge absorber is provided with a glass tube (2); a pair of sealing electrodes (3) which block openings at both ends of said glass tube (2) to seal discharge gas therein; and a plate-shaped insulator (4) having the pair of the sealing electrodes (3) arranged at both ends thereof, said insulator housed inside the glass tube (2). At least one of the two end portions (4a) of the plate-shaped insulator (4) has the same width as the inner diameter of the end portion of the glass tube (2), and at least the width of the intermediate portion (4b) of the plate-shaped insulator (4) is set narrower than the inner diameter of the end portion of the glass tube (2).

### BACKGROUND OF THE INVENTION

1. Field of the Invention

The present invention relates to a surge absorber that protects various equipment from a surge to be generated by lightning or the like and is used for preventing accident from happening and a method for manufacturing the same.

2. Description of the Related Art

A surge absorber is connected to a portion at which electronic equipment for communication devices such as telephones, fax machines, modems, and the like is in contact with a communication line, and a portion such as power lines, antennas, CRT drive circuits, and the like that is vulnerable to an electric shock due to abnormal voltage (surge voltage) such as lightning surge, static electricity, or the like in order to prevent electronic equipment or a printed circuit board mounted on electronic equipment from being damaged due to a thermal damage or ignitions caused by an abnormal voltage.

Conventionally, as a surge absorber having good responsiveness, Patent Document 1 proposes a surge absorber that employs a surge absorbing element having a micro gap. The surge absorber is a discharge-type surge absorber in which so-called “micro gap” is formed on the circumferential surface of a ceramic member that is a cylindrical insulating member provided with conductive coating, a surge absorbing element having a pair of cap electrodes on the opposite ends of the ceramic member is housed in a glass tube together with a discharge control gas, and a sealing electrode having lead wires on the opposite ends of the cylindrical glass tube is sealed under a high-temperature heating.

As a method for manufacturing a surge absorber in which a surge absorbing element is housed in the glass tube, a surge absorber manufacturing method for performing heat treatment to a surge absorbing element and swelling the glass tube of the surge absorbing element by providing a pressure difference between the inside and the outside of the surge absorbing element so as to ensure space on the peripheral portion of the micro gap in the surge absorbing element is known as disclosed in Patent Document 2.

### PRIOR ART DOCUMENTS

### Patent Documents

Patent Document 1: Japanese Laid-Open Patent Publication No. 2003-282216

Patent Document 2: Japanese Laid-Open Patent Publication No. 63-121285

### SUMMARY OF THE INVENTION

### Problems to be Solved by the Invention

The following problems still remain in the conventional techniques described above.

Conventionally, in the case of enclosing a surge absorbing element in a glass tube, it is necessary to enclose a surge absorbing element in a glass tube without being touched with the glass tube in order to increase surge strength by ensuring a large internal space and to swell the glass tube sufficiently upon enclosure as disclosed in Patent Document 2. However, a surge absorbing element needs to be thick enough to be self-standing to facilitate the enclosing of the surge absorbing element in the glass tube. In this case, the volume of discharge gas is reduced due to narrow of the internal space, which may be one of factors for deteriorating surge strength. In the case of a self-standing surge absorbing element, the cross-sectional area of the surge absorbing element needs to be small in order to increase surge strength. However, the surface of the cross-sectional area needs to be complicated in shape so as to obtain a self-standing structure. In this case, an attempt to form a carbon trigger formed of a carbon rod on the surface of the surge absorbing element may bring undesirable difficulty in forming the carbon trigger because the carbon rod readily escapes from the surface thereof. There is also another method for attaching a cap electrode member, a metal piece, or the like to each end portion so as to make a thin surge absorbing element self-stand, resulting in increase in the number of parts and costs.

The present invention has been made in view of the aforementioned circumstances, and an object of the present invention is to provide a surge absorber that can ensure a sufficient internal space and can be easily assembled due to simple constitution, and a method for manufacturing the same.

The following problems still remain in the conventional techniques described above.

Conventionally, in the case of enclosing a surge absorbing element in a glass tube, the glass tube needs to be sufficiently swollen upon enclosure as disclosed in Patent Document 2 in order to increase surge strength by ensuring a large internal space. However, when a surge absorbing element or a cap electrode and a glass tube that are brought into contact with each other deform so as to be away from each other due to the difference in thermal expansion coefficients during swelling of the glass tube or after enclosure of the surge absorbing element, a force is exerted in a direction away from each other, whereby the fine crack appears on the inner surface of the glass tube, resulting in an undesirable decrease in surge strength.

The present invention has been made in view of the aforementioned circumstances, and an object of the present invention is to provide a surge absorber that can maintain excellent surge strength by controlling the occurrence of cracks on the inner surface of the glass tube so as not to decrease surge strength and a method for manufacturing the same.

### Means for Solving the Problems

The present invention adopts the following structure in order to solve the aforementioned problems. More specifically, the surge absorber of the present invention is characterized in that the surge absorber includes a glass tube; a pair of sealing electrodes which block openings at both ends of the glass tube to seal discharge gas therein; and a plate-shaped insulator having the pair of sealing electrodes arranged at both ends thereof, the insulator housed inside the glass tube, wherein at least one of the two end portions of the plate-shaped insulator has the same width as the inner diameter of the end portion of the glass tube and at least the width of the intermediate portion of the plate-shaped insulator is set narrower than the inner diameter of the end portion of the glass tube.

In the surge absorber, at least one of the two end portions of the plate-shaped insulator has the same width as the inner diameter of the end portion of the glass tube. Thus, when the plate-shaped insulator is enclosed in the glass tube upon assembling, the end portions of the plate-shaped insulator having the same width as the inner diameter of the end portion of the glass tube are positioned with respect to the end portions of the glass tube. Consequently, a thin plate-shaped insulator having a small cross-sectional area can be allowed to self-stand with high positional accuracy without using a cap electrode member, a metal piece, or the like and an internal space larger than that obtained in the case of a cylindrical insulator can be obtained.

In the case of a rectangular plate-shaped insulator having the same fixed width as the inner diameter of the glass tube, the internal space of the glass tube is completely divided into two parts. However, in the surge absorber of the present invention, at least the width of the intermediate portion of the plate-shaped insulator is set narrower than the inner diameter of the end portion of the glass tube. Thus, the space on the front side of the plate-shaped insulator communicates with the space on the back side thereof in the periphery of the intermediate portion, whereby a large internal space can be ensured without completely dividing the internal space of the glass tube into two parts and the surge strength can be further increased.

Also, the surge absorber of the present invention is characterized in that the two end portions of the plate-shaped insulator have the same width as the inner diameter of the end portion of the glass tube.

More specifically, in the surge absorber, the two end portions of the plate-shaped insulator have the same width as the inner diameter of the end portion of the glass tube. Thus, the plate-shaped insulator can be enclosed in the glass tube without aligning the upper and lower portions thereof with each other when the plate-shaped insulator is to be enclosed in the glass tube upon assembling, whereby assembly work becomes easy and can be carried out with high positional accuracy while suppressing the tilt of the plate-shaped insulator upon self-standing.

Furthermore, the surge absorber of the present invention is characterized in that a trigger portion formed of a conductive material is provided at the intermediate portion of at least one of the front surface and the back surface of the plate-shaped insulator.

More specifically, in the surge absorber, a trigger portion formed of a conductive material is provided at the intermediate portion of at least one of the front surface and the back surface of the plate-shaped insulator. Thus, trigger discharge (corona discharge) occurs via a trigger portion such as a carbon trigger or the like, resulting in obtaining high responsiveness. Since the front surface and the back surface of the plate-shaped insulator are flat surfaces, the trigger portion can be readily formed.

A method for manufacturing the surge absorber of the present invention is characterized in that the method includes achieving an assembled state by housing a plate-shaped insulator inside a glass tube, blocking openings at both ends of the glass tube using a pair of sealing electrodes, and sealing discharge gas in the glass tube; and softening the glass tube by heating it in the assembled state and outwardly swelling the intermediate portion of the softened glass tube by bringing the external pressure of the glass tube lower than the internal pressure thereof, wherein at least one of the two end portions of the plate-shaped insulator has the same width as the inner diameter of the end portion of the glass tube and at least the width of the intermediate portion of the plate-shaped insulator is set narrower than the inner diameter of the end portion of the glass tube.

More specifically, in the method for manufacturing the surge absorber, at least one of the two end portions of the plate-shaped insulator has the same width as the inner diameter of the end portion of the glass tube. Thus, when the plate-shaped insulator is enclosed in the glass tube, the end portions of the plate-shaped insulator having the same width as the inner diameter of the end portion of the glass tube are positioned with respect to the end portions of the glass tube. Consequently, a thin plate-shaped insulator having a small cross-sectional area can be allowed to self-stand with high positional accuracy without using a cap electrode member, a metal piece, or the like.

Also, when a glass tube housing a rectangular plate-shaped insulator is swollen by heating, the entire sides of the plate-shaped insulator become wet by being brought into contact with the inner surface of the glass tube, and thus, the glass tube does not swell toward the outside thereof. However, in the method for manufacturing the surge absorber of the present invention, at least the width of the intermediate portion of the plate-shaped insulator is set narrower than the inner diameter of the end portion of the glass tube. Thus, the intermediate portion is disposed away from the inner surface of the glass tube, and thus, the intermediate portion is not brought into contact with the inner surface of the glass tube, whereby the excellent swelling of the glass tube can be achieved.

Furthermore, the present invention adopts the following structure in order to solve the aforementioned problems. More specifically, the surge absorber of the present invention is characterized in that the surge absorber includes a glass tube; a pair of sealing electrodes which block openings at both ends of the glass tube to seal discharge gas therein; and an insulator having the pair of sealing electrodes arranged at both ends thereof directly or via a cap electrode, the insulator housed inside the glass tube, wherein a contact portion which is brought into abutment against the inner surface of the glass tube and of which the cross-sectional shape is convex in the axial direction of the glass tube is formed on the insulator or the cap electrode.

The method for manufacturing the surge absorber of the present invention is characterized in that the method includes achieving an assembled state by housing an insulator or an insulator having cap electrodes arranged at both ends thereof inside a glass tube, blocking openings at both ends of the glass tube using a pair of sealing electrodes, and sealing discharge gas in the glass tube; and softening the glass tube by heating it in the assembled state and outwardly swelling the intermediate portion of the softened glass tube by bringing the external pressure of the glass tube lower than the internal pressure thereof, wherein a contact portion which is brought into abutment against the inner surface of the glass tube and of which the cross-sectional shape is convex in the axial direction of the glass tube is formed on the insulator or the cap electrode.

In these surge absorbers and the method for manufacturing the same, a contact portion which is brought into abutment against the inner surface of the glass tube and of which the cross-sectional shape is convex in the axial direction of the glass tube is formed on the insulator or the cap electrode. Thus, the contact portion is brought into point contact or line contact with the inner surface of the glass tube and the contact angle between the contact portion and the inner surface of the glass tube in the axial direction is less than 90 degrees. With this arrangement, the contact area becomes small and the orientation of the stress generated by the difference in thermal expansion coefficient is controlled in a direction along which the cracks do not reach the outer surface of the glass tube, so that the reduction in surge strength can be suppressed. More specifically, the occurrence and progress of cracks are suppressed by decreasing the contact area and reducing the stress generated by the difference in thermal expansion coefficient. Even if cracks are generated, the cracks do not reach the outer surface of the glass tube but converge near the contact portion so that the cracks can be suppressed to an extent that only a portion of the inner surface of the glass tube is chipped off. Consequently, the glass tube is prevented from being broken.

Also, in the surge absorber of the present invention, it is preferable that the contact portion is spherical.

More specifically, in the surge absorber, the contact portion is spherical, and thus, the contact portion is brought into point contact with the inner surface of the glass tube. Thus, the contact area further becomes small and the stress generated by the difference in thermal expansion coefficient can further be reduced. Consequently, the occurrence and progress of cracks can further be suppressed.

Also, the surge absorber of the present invention is characterized in that the insulator is a plate-shaped insulator and the two end portions of the insulator have the same width as the inner diameter of the end portion of the glass tube, and the contact portion is formed on the two end portions of the insulator.

More specifically, in the surge absorber, the insulator is a plate-shaped insulator and the two end portions of the insulator have the same width as the inner diameter of the end portion of the glass tube, and the contact portion is formed on the two end portions of the insulator. Thus, the contact area between the contact portion formed in a plate shape and the inner surface of the glass tube further becomes small and the contact portion is brought into abutment against the two end portions of the glass tube while avoiding the intermediate portion of the glass tube at which high stress is generated due to the highest swelling, whereby the occurrence and progress of cracks can further be suppressed.

Even when the plate-shaped insulator is enclosed in the glass tube upon assembling, the end portions of the plate-shaped insulator having the same width as the inner diameter of the end portion of the glass tube are positioned with respect to the end portions of the glass tube. Consequently, a thin plate-shaped insulator having a small cross-sectional area can be allowed to self-stand with high positional accuracy without using a cap electrode member, a metal piece, or the like and an internal space larger than that obtained in the case of a cylindrical insulator can be obtained.

### Effects of the Invention

According to the present invention, the following effects may be provided.

More specifically, according to the surge absorber of the present invention and the method for manufacturing the same, at least one of the two end portions of the plate-shaped insulator has the same width as the inner diameter of the end portion of the glass tube and at least the width of the intermediate portion of the plate-shaped insulator is set narrower than the inner diameter of the end portion of the glass tube. Thus, a plate-shaped insulator can be allowed to self-stand with high positional accuracy without using a cap electrode member, a metal piece, or the like and a large internal space can be obtained, resulting in an increase in surge strength.

When a glass tube housing a plate-shaped insulator is swollen by heating, the width of the intermediate portion of the plate-shaped insulator is narrow, and thus, the intermediate portion is not brought into contact with the inner surface of the glass tube so that the excellent swelling of the glass tube can be achieved. In addition, the space on the front side of the plate-shaped insulator communicates with the space on the back side thereof, whereby a large internal space can be ensured.

According to the present invention, the following effects may also be provided.

More specifically, according to the surge absorber of the present invention and the method for manufacturing the same, a contact portion formed in a convex curved shape which is brought into abutment against the inner surface of the glass tube is formed on the insulator or the cap electrode. Thus, the contact area becomes small and the orientation of the stress generated by the difference in thermal expansion coefficient is controlled in a direction along which the cracks do not reach the outer surface of the glass tube, so that the reduction in surge strength can be suppressed.

### BRIEF DESCRIPTION OF THE DRAWINGS

FIG. 1 is a perspective view illustrating a surge absorber according to one embodiment of the present invention with a plate-shaped insulator being enclosed in a glass tube, a perspective view illustrating the surge absorber in an assembled state, and a cross-sectional view illustrating the surge absorber after heat-swelling.

FIG. 2 is a perspective view illustrating a surge absorber according to Comparative Example 1 of the present invention with a rectangular plate-shaped insulator being enclosed in a glass tube, a perspective view illustrating the surge absorber in an assembled state, and a cross-sectional view illustrating the surge absorber after heat-swelling.

FIG. 3 is a perspective view illustrating a surge absorber according to Comparative Example 2 of the present invention with a cylindrical insulator being enclosed in a glass tube, a perspective view illustrating the surge absorber in an assembled state, and a cross-sectional view illustrating the surge absorber after heat-swelling.

FIG. 4 is a perspective view illustrating a surge absorber according to a second embodiment of the present invention in an assembled state prior to heat-swelling and a cross-sectional view illustrating the surge absorber after heat-swelling.

FIG. 5 is an explanatory diagram illustrating the occurrence of cracks on the inner surface of the glass tube in the conventional example.

FIG. 6 is an explanatory diagram illustrating the occurrence of cracks on the inner surface of the glass tube in the second embodiment.

FIG. 7 is a cross-sectional view illustrating a surge absorber according to a third embodiment of the present invention in an assembled state prior to heat-swelling.

FIG. 8 is a perspective view illustrating a surge absorber according to Comparative Example of the present invention in an assembled state prior to heat-swelling and a cross-sectional view illustrating the surge absorber after heat-swelling.

### BEST MODES FOR CARING OUT THE INVENTION

### First Embodiment

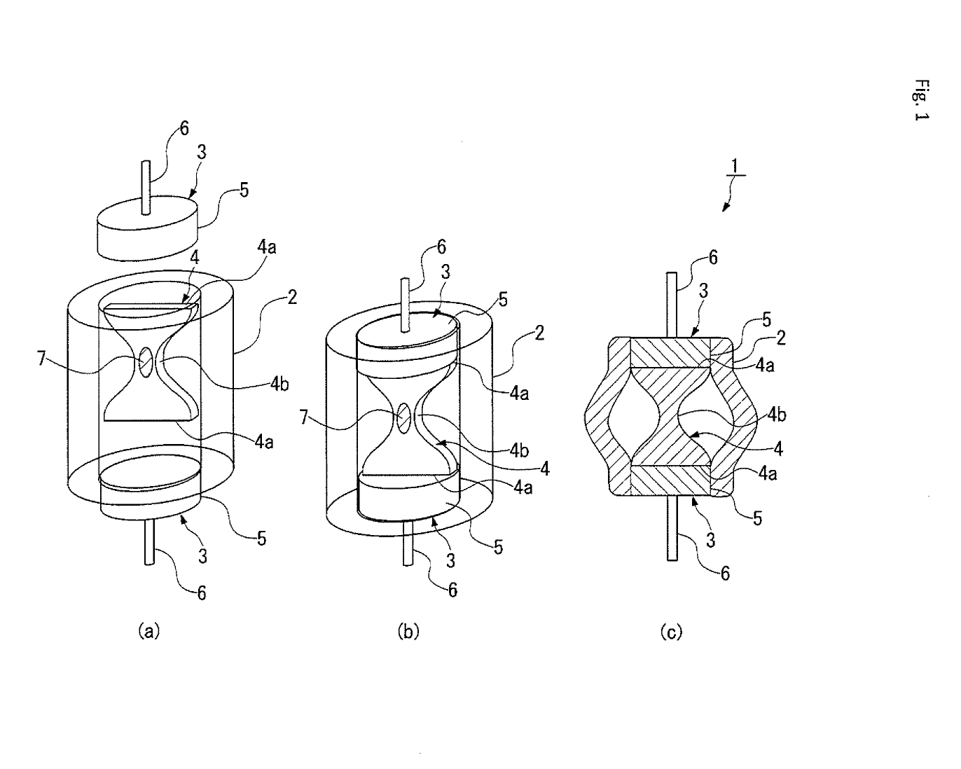

Hereinafter, a description will be given of a surge absorber according to one embodiment of the present invention with reference to FIG. 1. In the drawings used in the following description, the scale of each component is changed as appropriate so that each component is recognizable or is readily recognized.

As shown in FIG. 1, the surge absorber 1 of the present embodiment includes a glass tube 2, a pair of sealing electrodes 3 which block openings at both ends of the glass tube 2 to seal discharge gas therein, and a plate-shaped insulator 4 having the pair of the sealing electrodes 3 arranged at both ends thereof, the insulator 4 housed inside the glass tube 2.

The glass tube 2 is made of a lead glass or the like and is formed in a cylindrical shape.

The sealing electrode 3 is a slug lead that is constituted by a cylindrical electrode 5 and a lead wire 6 of which one end is embedded in the electrode 5. The sealing electrode 3 is fixed in intimate contact with the glass tube 2 by fusing the electrode 5 fitted in the glass tube 2 by heat treatment.

A discharge gas to be enclosed in the glass tube 2 is an inert gas or the like. Examples of such inert gas to be employed include He, Ar, Ne, Xe, Kr, SF₆, CO₂, C₃F₈, C₂F₆, CF₄, H₂, atmosphere, and a mixed gas thereof.

The plate-shaped insulator 4 is made of a ceramic material such as alumina, mullite, corundum mullite, or the like and is formed in a thin plate shape. The plate-shaped insulator 4 of the present embodiment is formed of alumina.

The two end portions 4a of the plate-shaped insulator 4 have the same width as the inner diameter of the end portion of the glass tube 2 and the width of the intermediate portion 4b is set narrower than the inner diameter of the end portion of the glass tube 2. More specifically, the intermediate portion 4b of the plate-shaped insulator 4 is narrowed down.

The width of the two end portions 4a of the plate-shaped insulator 4 is set to be the same as the inner diameter of the glass tube 2 within the range of the tolerance of 0.1 mm.

Also, a trigger portion 7 formed of a conductive material such as carbon is provided at the intermediate portion between the front surface and the back surface of the plate-shaped insulator.

Next, a description will be given of a method for manufacturing the surge absorber 1 with reference to FIGS. 1(a) to 1(c).

Firstly, as shown in FIG. 1(a), in a discharge gas atmosphere, the plate-shaped insulator 4 is enclosed in the glass tube 2 from the opening in the upper end of the glass tube 2 and is housed therein in a state in which one sealing electrode 3 is fitted in the opening in the lower end of the glass tube 2. At this time, since the two end portions 4a of the plate-shaped insulator 4 are set to have the same width as the inner diameter of the glass tube 2, the two end portions 4a are positioned to be brought into abutment against the inner surface of the glass tube 2 so that the plate-shaped insulator 4 is housed in the center of the glass tube 2 in a self-stand state.

Furthermore, as shown in FIG. 1(b), the opening in the upper end of the glass tube 2 is blocked by the other sealing electrode 3, and thus, the openings at both ends of the glass tube 2 are blocked by the sealing electrodes 3 while a discharge gas is sealed in the glass tube 2 so that the glass tube 2 is in an assembled state.

Next, as shown in FIG. 1(c), the glass tube 2 is softened by heating it as high as the softening point of the glass tube 2 in the assembled state and the intermediate portion 4b of the softened glass tube 2 is swollen outwardly by bringing the external pressure of the glass tube 2 lower than the internal pressure thereof. More specifically, the vacuum state is established by reducing the pressure on the exterior of the glass tube 2, and then, the softened glass tube 2 is swollen outward in the radial direction by the pressure difference between the inside and the outside of the glass tube 2. At this time, the intermediate portion 4b of the plate-shaped insulator 4 is narrowed down, and thus, the intermediate portion 4b is not brought into contact with the inner surface of the glass tube 2 so as not to prevent the swelling of the glass tube 2. By cooling the glass tube 2 in the assembled state, the glass tube 2 is hardened with the intermediate portion 4b swollen and the sealing electrodes 3 are fused on the two end portions of the glass tube 2, whereby the surge absorber 1 is produced.

In the surge absorber 1, when the over-voltage or the over-current enters, the trigger discharge is firstly performed between the trigger portion 7 of the plate-shaped insulator 4 and the sealing electrode 3, and then the discharge that is triggered by the trigger discharge is further developed between a pair of sealing electrodes 3, and thus, the surge is absorbed.

As described above, in the surge absorber 1 of the present embodiment, the two end portions 4a of the plate-shaped insulator 4 have the same width as the inner diameter of the end portion of the glass tube 2. Thus, when the plate-shaped insulator 4 is enclosed in the glass tube 2 upon assembling, the two end portions 4a of the plate-shaped insulator 4 having the same width as the inner diameter of the end portion of the glass tube 2 are positioned with respect to the end portions of the glass tube 2. Consequently, a thin plate-shaped insulator 4 having a small cross-sectional area can be allowed to self-stand with high positional accuracy without using a cap electrode member, a metal piece, or the like and an internal space larger than that obtained in the case of a cylindrical insulator can be obtained.

Furthermore, both the two end portions 4a of the plate-shaped insulator 4 have the same width as the inner diameter of the end portion of the glass tube 2. Thus, the plate-shaped insulator 4 can be enclosed in the glass tube 2 without aligning the upper and lower portions thereof when the plate-shaped insulator 4 is to be enclosed in the glass tube 2 upon assembling, whereby assembly work becomes easy and can be carried out with high positional accuracy while suppressing the tilt of the plate-shaped insulator 4 upon self-standing.

Also, the width of the intermediate portion 4b of the plate-shaped insulator 4 is set narrower than the inner diameter of the end portion of the glass tube 2. Thus, the space on the front side of the plate-shaped insulator 4 communicates with the space on the back side thereof in the periphery of the intermediate portion 4b, whereby a large internal space can be ensured without completely dividing the internal space of the glass tube 2 into two parts and the surge strength can be further increased.

Furthermore, the width of the intermediate portion 4b of the plate-shaped insulator 4 is set narrower than the inner diameter of the end portion of the glass tube 2. Thus, the intermediate portion 4b is disposed away from the inner surface of the glass tube 2, and thus, the intermediate portion 4b is not brought into contact with the inner surface of the glass tube 2, whereby the excellent swelling of the glass tube 2 can be achieved.

Also, the trigger portion 7 formed of a conductive material is provided at the intermediate portion between the front surface and the back surface of the plate-shaped insulator 4. Thus, trigger discharge (corona discharge) occurs via a trigger portion 7, resulting in obtaining high responsiveness.

### EXAMPLE 1

Next, the surge absorber of the present invention will be specifically described with reference to the evaluation result of the actually produced surge absorber by way of Example, based on the aforementioned embodiment.

As the surge absorber 1 of the aforementioned embodiment, the plate-shaped insulator 4 was produced with alumina in a dimension with a maximum width of 2.5 mm (the width of two end portions), a minimum width of 1 mm (the width of intermediate portion), a thickness of 0.5 mm, and a length of 3 mm, and then the plate-shaped insulator 4 was enclosed in the glass tube 2 having an inner diameter of 2.5 mm to thereby produce the surge absorber 1 in Example 1. Then, the surge strength of the surge absorber 1 was measured and evaluated.

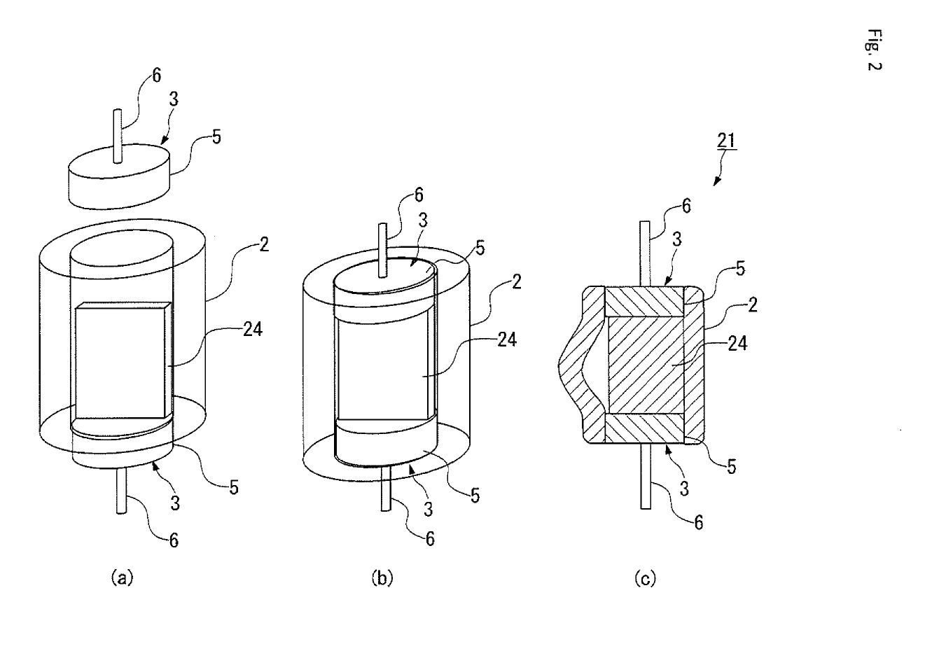

As a surge absorber 21 in Comparative Example 1, as shown in FIG. 2, a rectangular plate-shaped insulator 24 was produced with alumina in a dimension with a width of 2.5 mm, a thickness of 0.5 mm, and a length of 3 mm, and then the rectangular plate-shaped insulator 24 was enclosed in the glass tube 2 having an inner diameter of 2.5 mm to thereby produce the surge absorber 21 in Comparative Example 1. Then, the surge strength of the surge absorber 21 was measured and evaluated. As shown in FIGS. 2(a) and 2(b), when the plate-shaped insulator 24 was enclosed and housed in the glass tube 2 of the surge absorber 21 in Comparative Example 1, the entire sides of the plate-shaped insulator 24 were brought into contact with the inner surface of the glass tube 2. Thus, as shown in FIG. 2(c), the surge absorber 21 in which a part of the glass tube 2 was not swollen due to bonding of the plate-shaped insulator 24 with the glass tube 2 upon swelling by heat treatment was used.

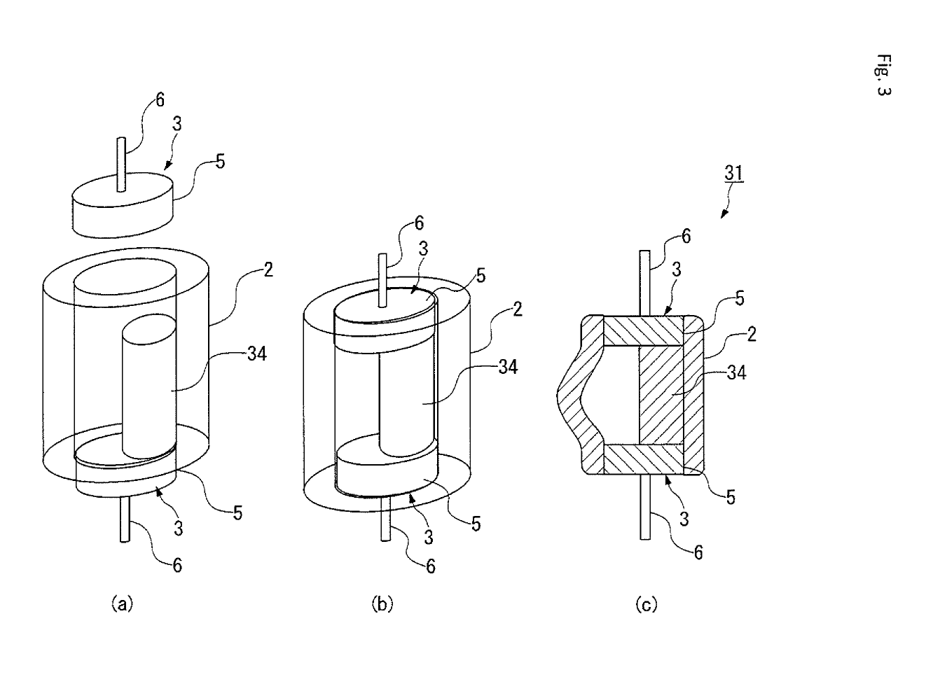

Furthermore, as a surge absorber 31 in Comparative Example 2, as shown in FIG. 3, a cylindrical insulator 34 was produced with alumina in a dimension with a diameter of 1.6 mm and a length of 3 mm, and then the cylindrical insulator 34 was enclosed in the glass tube 2 having an inner diameter of 2.5 mm to thereby produce the surge absorber 31 in Comparative Example 2. Then, the surge strength of the surge absorber 31 was measured and evaluated. As shown in FIGS. 3(a) and 3(b), the enclosed cylindrical insulator 34 of the surge absorber 31 in Comparative Example 2 was misaligned with respect to the glass tube 2 and the entire sides of the cylindrical insulator 34 were brought into contact with the inner surface of the glass tube 2. Thus, as shown in FIG. 3C, the surge absorber 31 in which a part of the glass tube 2 was not swollen due to bonding of the cylindrical insulator 34 with the glass tube 2 upon swelling by heat treatment was used.

The conditions for measuring surge strength were as follows. An impulse current having a waveform of 8/20 μs was applied to a serge absorber three times and the maximum current value that did not cause any break in the serge absorber was determined as surge strength. These measurement results are shown in the following Table 1.

TABLE 1

| | EXAMPLE | COMPARATIVE EXAMPLE 1 | COMPARATIVE EXAMPLE 2 |
|---|---|---|---|
| MANUFACTURING | MAXIMUM WIDTH: 2.5 mm | MAXIMUM WIDTH: 2.5 mm | DIAMETER: 1.6 mm |
| CONDITIONS | MINIMUM WIDTH: 1 mm | THICKNESS: 0.5 mm | LENGTH: 3 mm, CYLINDER |
| | THICKNESS: 0.5 mm | LENGTH: 3 mm, RECTANGULAR | MADE OF ALUMINA |
| | LENGTH: 3 mm | MADE OF ALUMINA | |
| | MADE OF ALUMINA | | |
| SURGE STRENGTH | 3400 A | 2200 A | 2200 A |

NOTE:
SURGE STRENGTH: AN IMPULSE CURRENT HAVING A WAVEFORM OF 8/20 μs WAS APPLIED TO A SERGE ABSORBER THREE TIMES AND THE MAXIMUM CURRENT VALUE THAT DID NOT CAUSE ANY BREAK IN THE SERGE ABSORBER HAS DETERMINED AS SURGE STRENGTH

As the results of evaluation, the surge strength was 2200 A in Comparative Examples 1 and 2, whereas the surge strength in Example 1 was 3400 A. Thus, it is found that higher surge strength was obtained in Example 1. As described above, in Example 1, the glass tube 2 was favorably swollen and a sufficient internal space was ensured by the plate-shaped insulator 4 of which the intermediate portion 4b was narrowed down, whereby high surge strength was obtained by a large discharge space and the volume of discharge gas.

The technical scope of the present invention is not limited to the aforementioned embodiments, but the present invention may be altered in various ways without departing from the scope or teaching of the present invention.

For example, although it is preferable that the two end portions of the plate-shaped insulator have the same width as the inner diameter of the end portion of the glass tube as described in the embodiment, at least one of the two end portions of the plate-shaped insulator may have the same width as the inner diameter of the end portion of the glass tube.

### Second and Third Embodiments

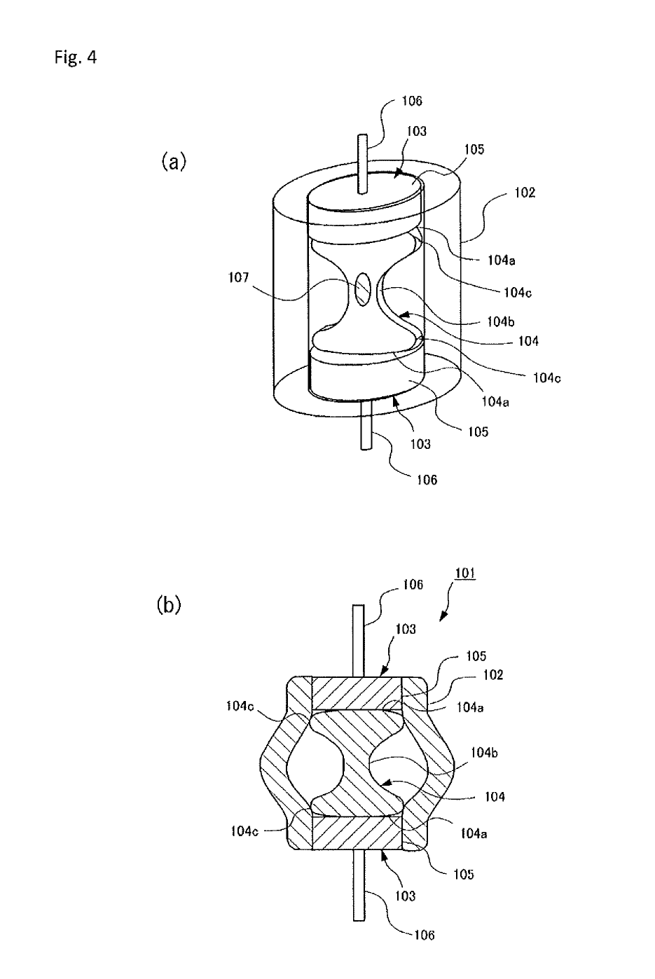

Hereinafter, a description will be given of a surge absorber according to a second embodiment of the present invention with reference to FIGS. 4 to 6. In the drawings used in the following description, the scale of each component is changed as appropriate so that each component is recognizable or is readily recognized.

As shown in FIG. 4, the surge absorber 101 of the present embodiment includes a glass tube 102, a pair of sealing electrodes 103 which block openings at both ends of the glass tube 102 to seal discharge gas therein, and a plate-shaped insulator 104 having the pair of the sealing electrodes 103 arranged at both ends thereof, the insulator 104 housed inside the glass tube 102.

The glass tube 102 is made of a lead glass or the like and is formed in a cylindrical shape.

The sealing electrode 103 is a slug lead that is constituted by a cylindrical electrode 105 and a lead wire 106 of which one end is embedded in the electrode 105. The sealing electrode 103 is fixed in intimate contact with the glass tube 102 by fusing the electrode 105 fitted in the glass tube 102 by heat treatment.

A discharge gas to be enclosed in the glass tube 102 is an inert gas or the like. Examples of such inert gas to be employed include He, Ar, He, Xe, Kr, SF₆, CO₂, C₃F₈, C₂F₆, CF₄, H₂, atmosphere, and a mixed gas thereof.

The plate-shaped insulator 104 is made of a ceramic material such as alumina, mullite, corundum mullite, or the like and is formed in a thin plate shape. The plate-shaped insulator 104 of the present embodiment is formed of alumina.

The two end portions 104a of the plate-shaped insulator 104 have the same width as the inner diameter of the end portion of the glass tube 102 and the width of the intermediate portion 104b is set narrower than the inner diameter of the end portion of the glass tube 102. More specifically, the intermediate portion 104b of the plate-shaped insulator 104 is narrowed down.

The width of the two end portions 104a of the plate-shaped insulator 104 is set to be the same as the inner diameter of the glass tube 102 within the range of the tolerance of 0.1 mm.

Also, a contact portion 104c which is brought into abutment against the inner surface of the glass tube 102 and of which the cross-sectional shape is convex in the axial direction of the glass tube 102 is formed on each of the two end portions 104a of the plate-shaped insulator 104. The contact surface of the contact portion 104c is spherical.

Furthermore, a trigger portion 107 formed of a conductive material such as carbon is provided at the intermediate portion between the front surface and the back surface of the plate-shaped insulator 104. The trigger portion 107 is formed as required.

Next, a description will be given of a method for manufacturing the surge absorber 101 with reference to FIGS. 4 to 6.

Firstly, in a discharge gas atmosphere, the plate-shaped insulator 104 is enclosed in the glass tube 102 from the opening in the upper end of the glass tube 102 and is housed therein in a state in which one sealing electrode 103 is fitted in the opening in the lower end of the glass tube 102. At this time, since the two end portions 104a of the plate-shaped insulator 104 are set to have the same width as the inner diameter of the glass tube 102, the two end portions 104a are positioned to be brought into abutment against the inner surface of the glass tube 102 so that the plate-shaped insulator 104 is housed in the center of the glass tube 102 in a self-stand state.

Furthermore, as shown in FIG. 4(a), the opening in the upper end of the glass tube 102 is blocked by the other sealing electrode 103, and thus, the openings at both ends of the glass tube 102 are blocked by the sealing electrodes 103 while a discharge gas is sealed in the glass tube 102 so that the glass tube 102 is in an assembled state.

Next, as shown in FIG. 4(b), the glass tube 102 is softened by heating it as high as the softening point of the glass tube 102 in the assembled state and the intermediate portion 104b of the softened glass tube 102 is swollen outwardly by bringing the external pressure of the glass tube 102 lower than the internal pressure thereof. More specifically, the vacuum state is established by reducing the pressure on the exterior of the glass tube 102, and then, the softened glass tube 102 is swollen outward in the radial direction by the pressure difference between the inside and the outside of the glass tube 102.

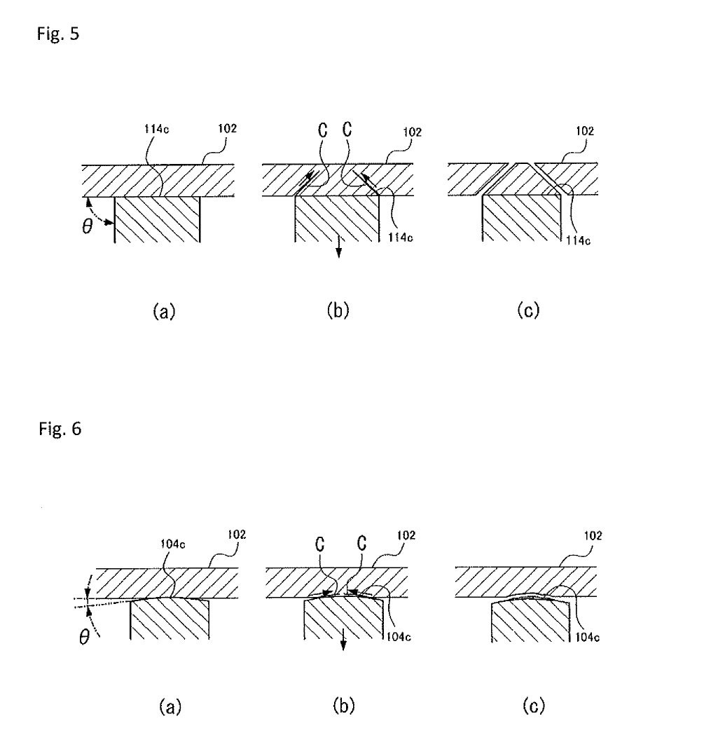

At this time, as shown in FIG. 5(a), when the contact portion 114c of the insulator, which is brought into abutment against the inner surface of the glass tube 102, is a substantially flat surface that is brought into surface contact with the inner surface of the glass tube 102 and the contact angle θ between the contact portion 114c and the inner surface of the glass tube 102 in the axial direction is equal to or greater than 90 degrees, a crack C occurs on the inner surface of the glass tube 102 due to the stress caused by the difference in thermal expansion coefficient as shown in FIG. 5B if the contact portion 114c is bonded against the inner surface of the softened glass tube 102. The crack C generated at this time is formed outward in the radial direction of the glass tube 102 with a wide tilt angle. Furthermore, as shown in FIG. 5(c), when the glass tube 102 is swollen, the crack C reaches the outer surface of the glass tube 102, resulting in the break of the glass tube 102.

In contrast, in the present embodiment, as shown in FIG. 6(a), when the contact portion 104c of the insulator 104, which is brought into abutment against the inner surface of the glass tube 102, is a convex surface that is brought into point contact with the inner surface of the glass tube 102 and the contact angle θ between the contact portion 104c and the inner surface of the glass tube 102 in the axial direction is less than 90 degrees, a crack C occurs on the inner surface of the glass tube 102 due to the stress caused by the difference in thermal expansion coefficient as shown in FIG. 6(b) if the contact portion 104c is bonded against the inner surface of the softened glass tube 102. The crack C generated at this time is formed outward in the axial direction of the glass tube 102 with a wide tilt angle. Furthermore, as shown in FIG. 6(c), when the glass tube 102 is swollen, the crack C converges on the inner surface of the glass tube 102. Thus, only a part of the inner surface of the glass tube 102 is chipped off by being bonded to the contact portion 104c so that the crack C does not reach the outer surface of the glass tube 102, resulting in no break in the glass tube 102.

Since the intermediate portion 104b of the plate-shaped insulator 104 has already been narrowed down during the swelling step, the intermediate portion 104b is not brought into contact with the inner surface of the glass tube 102 so as not to prevent the swelling of the glass tube 102.

By cooling the glass tube 102 in the assembled state, the glass tube 102 is hardened with the intermediate portion 104b swollen and the sealing electrodes 103 are fused on the two end portions of the glass tube 102, whereby the surge absorber 101 is produced.

In the surge absorber 101, when the over-voltage or the over-current enters, the trigger discharge is firstly performed between the trigger portion 107 of the plate-shaped insulator 104 and the sealing electrode 103, and then the discharge that is triggered by the trigger discharge is further developed between a pair of sealing electrodes 103, and thus, the surge is absorbed.

As described above, in the surge absorber 101 and the method for manufacturing the same, a contact portion 104c which is brought into abutment against the inner surface of the glass tube 102 and of which the cross-sectional shape is convex in the axial direction of the glass tube 102 is formed on the plate-shaped insulator 104. Thus, the contact portion 104c is brought into point contact or line contact with the inner surface of the glass tube 102 and the contact angle A between the contact portion 104c and the inner surface of the glass tube 102 in the axial direction is less than 90 degrees. With this arrangement, the contact area becomes small and the orientation of the stress generated by the difference in thermal expansion coefficient is controlled in a direction along which the crack C does not reach the outer surface of the glass tube 102, so that the reduction in surge strength can be suppressed.

More specifically, the occurrence and progress of the crack C are suppressed by decreasing the contact area and reducing the stress generated by the difference in thermal expansion coefficient. Even if the crack C is generated, the crack C does not reach the outer surface of the glass tube 102 but converge near the contact portion 104c so that the crack C can be suppressed to an extent that only a portion of the inner surface of the glass tube 102 is chipped off. Consequently, the glass tube 102 is prevented from being broken.

In particular, the contact portion 104c is spherical, and thus, the contact portion 104c is brought into point contact with the inner surface of the glass tube 102. Thus, the contact area further becomes small and the stress generated by the difference in thermal expansion coefficient can further be reduced. Consequently, the occurrence and progress of the crack C can further be suppressed.

The insulator of the present embodiment is the plate-shaped insulator 104 and the two end portions 104a of the insulator 104 have the same width as the inner diameter of the end portion of the glass tube 102, and the contact portion 104c is formed on the two end portions 104a of the plate-shaped insulator 104. Thus, the contact area between the contact portion 104c formed in a plate shape and the inner surface of the glass tube 102 further becomes small and the contact portion 104c is brought into abutment against the two end portions of the glass tube 102 while avoiding the intermediate portion of the glass tube 102 at which high stress is generated due to the highest swelling, whereby the occurrence and progress of the crack C can further be suppressed.

Even when the plate-shaped insulator 104 is enclosed in the glass tube 102 upon assembling, the two end portions 104a of the plate-shaped insulator 104 having the same width as the inner diameter of the end portion of the glass tube 102 are positioned with respect to the end portions of the glass tube 102. Consequently, a thin plate-shaped insulator 104 having a small cross-sectional area can be allowed to self-stand with high positional accuracy without using a cap electrode member, a metal piece, or the like and an internal space larger than that obtained in the case of a cylindrical insulator can be obtained.

Also, the width of the intermediate portion 104b of the plate-shaped insulator 104 is set narrower than the inner diameter of the end portion of the glass tube 102. Thus, the space on the front side of the plate-shaped insulator 104 communicates with the space on the back side thereof in the periphery of the intermediate portion 104b, whereby a large internal space can be ensured without completely dividing the internal space of the glass tube 102 into two parts and the surge strength can be further increased.

Furthermore, the width of the intermediate portion 104b of the plate-shaped insulator 104 is set narrower than the inner diameter of the end portion of the glass tube 102. Thus, the intermediate portion 104b is disposed away from the inner surface of the glass tube 102, and thus, the intermediate portion 104b is not brought into contact with the inner surface of the glass tube 102, whereby the excellent swelling of the glass tube 102 can be achieved.

Also, the trigger portion 107 formed of a conductive material is provided at the intermediate portion between the front surface and the back surface of the plate-shaped insulator 104. Thus, trigger discharge (corona discharge) occurs via a trigger portion 107, resulting in obtaining high responsiveness.

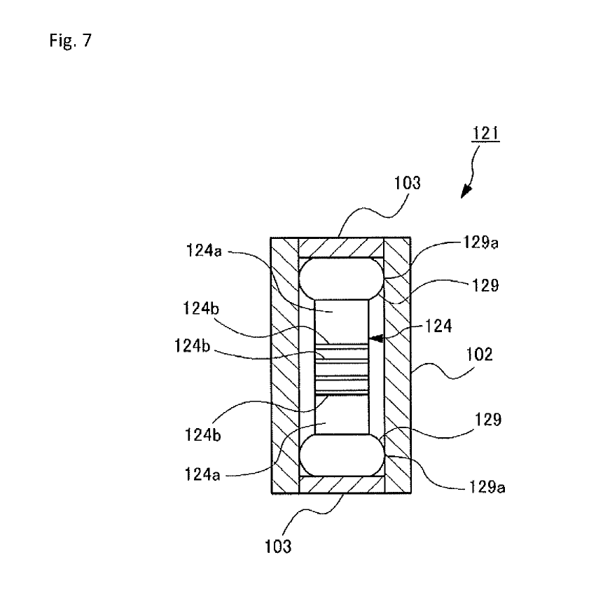

Next, a description will be given below of a surge absorber according to a third embodiment of the present invention and a method for manufacturing the same with reference to FIG. 7. In the following description, the same elements as those described in the aforementioned embodiments are designated by the same reference numerals and explanation thereof will be omitted.

The difference of the third embodiment from the second embodiment is as follows. Although, in the second embodiment, the plate-shaped insulator 104 as an insulator is housed in the glass tube 102, the surge absorber 121 of the third embodiment is a micro gap-type surge absorber as shown in FIG. 7 in which a cylindrical insulator 124 having a pair of cap electrodes 129 arranged at both ends thereof is arranged between a pair of sealing electrodes 103, where the contact portion 104c is formed on the outer peripheral surface of a cap electrode 129.

More specifically, in the third embodiment, the cap electrode 129 is formed in a substantially cylindrical shape in which the outer peripheral surface thereof is swollen, and a contact portion 129a which is brought into abutment against the inner surface of the glass tube 102 and of which the cross-sectional shape is arcuate convex in the axial direction of the glass tube 102 is formed on the outer peripheral surface of the cap electrode 129. On the outer peripheral surface of the cylindrical insulator 124, a conductive coating film 124a such as TiN is formed and is divided by a plurality of micro gaps 124b as discharge gaps.

Also in the surge absorber 121 of the third embodiment, the contact portion 129a which is brought into abutment against the inner surface of the glass tube 102 and of which the cross-sectional shape is arcuate convex in the axial direction of the glass tube 102 is formed on the cap electrode 129. Thus, the contact portion 129a is brought into line contact with the inner surface of the glass tube 102 and the contact angle between the contact portion 129a and the inner surface of the glass tube 102 in the axial direction is less than 90 degrees. With this arrangement, the contact area becomes small and the orientation of the stress generated by the difference in thermal expansion coefficient is controlled in a direction along which the cracks do not reach the outer surface of the glass tube 102, so that the reduction in surge strength can be suppressed.

### EXAMPLE 2

Next, the surge absorber of the present invention will be specifically described with reference to the evaluation result of the actually produced surge absorber by way of Example, based on the aforementioned embodiment.

As the surge absorber 101 of the aforementioned second embodiment, the plate-shaped insulator 104 was produced with alumina in a dimension with a maximum width of 2.5 mm (the width of two end portions), a minimum width of 1 mm (the width of intermediate portion), a thickness of 0.5 mm, and a length of 3 mm, where the contact portion 104c of the plate-shaped insulator 104 was formed in a spherical shape. The resulting plate-shaped insulator 104 was enclosed in the glass tube 102 having an inner diameter of 2.5 mm to thereby produce the surge absorber 101. Then, the surge strength of the surge absorber 101 was measured and evaluated.

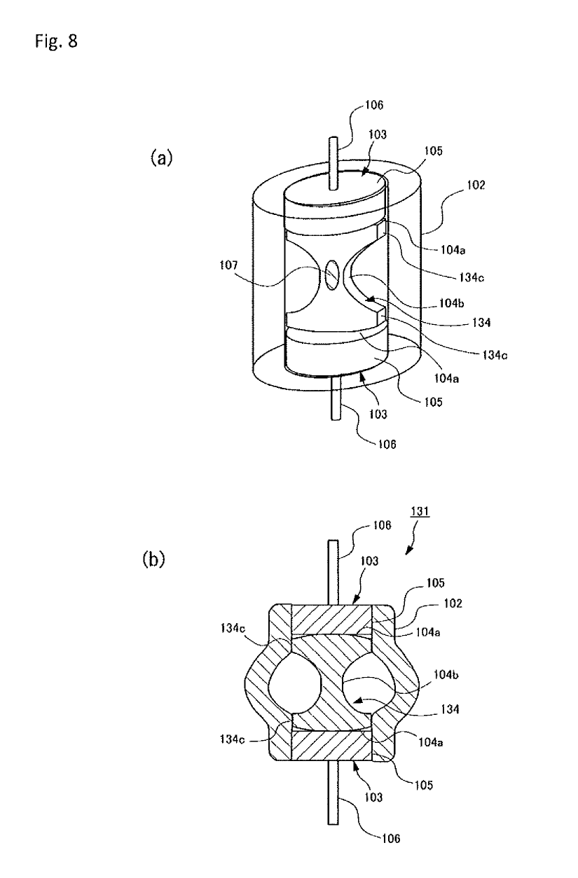

As a surge absorber 131 in Comparative Example, as shown in FIG. 8, a plate-shaped insulator 134 was produced with alumina in a dimension with a width of 2.5 mm, a thickness of 0.5 mm, and a length of 3 mm, where the contact portion 134c of the plate-shaped insulator 134 had a square shape having a substantially flat surface. The resulting plate-shaped insulator 134 was enclosed in the glass tube 102 having an inner diameter of 2.5 mm to thereby produce the surge absorber 131. Then, the surge strength of the surge absorber 131 was measured and evaluated.

The conditions for measuring surge strength were as follows. An impulse current having a waveform of 8/20 has was applied to a surge absorber three times and the maximum current value that did not cause any break in the serge absorber was determined as surge strength. These measurement results are shown in the following Table 2.

TABLE 2

| | EXAMPLE | COMPARATIVE EXAMPLE |
|---|---|---|
| MANUFACTURING | MAXIMUM WIDTH: 2.5 mm | MAXIMUM WIDTH: 2.5 mm |
| CONDITIONS | MINIMUM WIDTH: 1 mm | MINIMUM WIDTH: 1 mm |
| | THICKNESS: 0.5 mm | THICKNESS: 0.5 mm |
| | LENGTH: 3 mm | LENGTH: 3 mm |
| | SPHERICAL END | SQUARE END |
| | MADE OF ALUMINA | MADE OF ALUMINA |
| SURGE STRENGTH | 3400 A | 2800 A |

NOTE:
SURGE STRENGTH: AN IMPULSE CURRENT HAVING A WAVEFORM OF 8/20 μs HAS APPLIED TO A SERGE ABSORBER THREE TIMES AND THE MAXIMUM CURRENT VALUE THAT DID NOT CAUSE ANY BREAK IN THE SERGE ABSORBER WAS DETERMINED AS SURGE STRENGTH

As the results of evaluation, the surge strength was 2800 A in Comparative Example, whereas the surge strength in Example was 3400 A. Thus, it is found that higher surge strength was obtained in Example. As described above, in Example, the contact portion 134c having a convex shape was brought into point contact with the inner surface of the glass tube 102 and the contact angle between the contact portion 134c and the inner surface of the glass tube 102 in the axial direction was less than 90 degrees. Thus, the contact area became small and the progress direction of cracks was controlled, resulting in an increase in surge strength.

The technical scope of the present invention is not limited to the aforementioned embodiments, but the present invention may be altered in various ways without departing from the scope or teaching of the present invention.

### REFERENCE NUMERALS

1, 21, 31, 101, 121, 131: surge absorber, 2, 102: glass tube, 3, 103: sealing electrode, 4, 24, 104, 134: plate-shaped insulator, 4a, 104a: two end portions of the plate-shaped insulator, 4b, 104b: intermediate portion of the plate-shaped insulator, 104c, 114c, 129a, 134c: contact portion, 7, 107: trigger portion, 124: cylindrical insulator, 129: cap electrode

What is claimed is:

1. A surge absorber comprising:
a glass tube;
a pair of sealing electrodes which block openings at both ends of the glass tube to seal discharge gas therein; and
a plate-shaped insulator having the pair of sealing electrodes arranged at both ends thereof, the insulator housed inside the glass tube,
wherein at least one of the two end portions of the plate-shaped insulator has the same width as the inner diameter of the end portion of the glass tube and at least the width of the intermediate portion of the plate-shaped insulator is set narrower than the inner diameter of the end portion of the glass tube.

2. The surge absorber according to claim 1, wherein the two end portions of the plate-shaped insulator have the same width as the inner diameter of the end portion of the glass tube.

3. The surge absorber according to claim 1, wherein a trigger portion formed of a conductive material is provided at the intermediate portion of at least one of the front surface and the back surface of the plate-shaped insulator.

4. A method for manufacturing a surge absorber, comprising:
achieving an assembled state by housing a plate-shaped insulator inside a glass tube, blocking openings at both ends of the glass tube using a pair of sealing electrodes, and sealing discharge gas in the glass tube; and
softening the glass tube by heating it in the assembled state and outwardly swelling the intermediate portion of the softened glass tube by bringing the external pressure of the glass tube lower than the internal pressure thereof,
wherein at least one of the two end portions of the plate-shaped insulator has the same width as the inner diameter of the end portion of the glass tube and at least the width of the intermediate portion of the plate-shaped insulator is set narrower than the inner diameter of the end portion of the glass tube.

5. A surge absorber comprising:
a glass tube;
a pair of sealing electrodes which block openings at both ends of the glass tube to seal discharge gas therein; and
an insulator having the pair of sealing electrodes arranged at both ends thereof directly or via a cap electrode, the insulator housed inside the glass tube,
wherein a contact portion which is brought into abutment against the inner surface of the glass tube and of which the cross-sectional shape is convex in the axial direction of the glass tube is formed on the insulator or the cap electrode.

6. The surge absorber according to claim 5, wherein the contact portion is spherical.

7. The surge absorber according to claim 5, wherein the insulator is a plate-shaped insulator and the two end portions of the insulator have the same width as the inner diameter of the end portion of the glass tube, and the contact portion is formed on the two end portions of the insulator.

8. The surge absorber according to claim 5, wherein the insulator is a plate-shaped insulator and a trigger portion formed of a conductive material is provided at the intermediate portion of at least one of the front surface and the back surface of the plate-shaped insulator.

9. A method for manufacturing a surge absorber, comprising:
achieving an assembled state by housing an insulator or an insulator having cap electrodes arranged at both ends thereof inside a glass tube, blocking openings at both ends of the glass tube using a pair of sealing electrodes, and sealing discharge gas in the glass tube; and
softening the glass tube by heating it in the assembled state and outwardly swelling the intermediate portion of the softened glass tube by bringing the external pressure of the glass tube lower than the internal pressure thereof,
wherein a contact portion which is brought into abutment against the inner surface of the glass tube and of which the cross-sectional shape is convex in the axial direction of the glass tube is formed on the insulator or the cap electrode.
